(19) United States
(12) Patent Application Publication
(10) Pub. No.: US 2026/0268847 A1
(43) Pub. Date: Sep. 10, 2026

(54) DISPLAY DEVICE

(71) Applicant: Sharp Display Technology Corporation, Kameyama City, Mie (JP)

(72) Inventor: Tsuyoshi INOUE, Kameyama City, Mie (JP)

(21) Appl. No.: 19/110,922

(22) PCT Filed: Sep. 20, 2022
(86) PCT No.: PCT/JP2022/034878

§ 371 Date: Mar. 12, 2025

(51) Int. Cl. G09G 3/3233

(52) U.S. Cl. CPC G09G 3/3233; G09G 2320/0271

(57) ABSTRACT

A display device includes: a display portion including a plurality of subpixels; and a control unit configured to control light emission of the plurality of subpixels based on an image signal. Each of the plurality of subpixels includes a first light-emitting region including a first area and a second light-emitting region including a second area larger than the first area. The control unit causes the first light-emitting region to emit light and the second light-emitting region not to emit light in a case in which a gray scale value represented by the image signal is greater than 0 and less than a first threshold value, and causes the second light-emitting region to emit light in a case in which the gray scale value represented by the image signal is equal to or greater than the first threshold value.

### BACKGROUND ART

PTL 1 discloses a method for controlling film thickness of an organic material layer by dividing a pixel electrode within a pixel and subdividing a region to be applied.

### CITATION LIST

### Patent Literature

PTL 1: JP 2007-18775 A

### SUMMARY

### Technical Problem

In a display device including a light-emitting element, due to characteristic variations between the light-emitting elements, display quality of a low gray scale tends to be degraded.

### Solution to Problem

A display device according to an aspect of the disclosure includes: a display portion including a plurality of subpixels; and a control unit configured to control light emission of the plurality of subpixels based on an image signal, in which each of the plurality of subpixels includes a first light-emitting region including a first area and a second light-emitting region including a second area larger than the first area, the control unit causes the first light-emitting region to emit light and the second light-emitting region not to emit light in a case in which a gray scale value represented by the image signal is greater than 0 and less than a first threshold value, and causes the second light-emitting region to emit light in a case in which the gray scale value represented by the image signal is equal to or greater than the first threshold value.

### Advantageous Effects of Disclosure

According to an aspect of the disclosure, the display quality of the low gray scale can be improved.

### BRIEF DESCRIPTION OF DRAWINGS

FIG. 1 is a schematic diagram illustrating a configuration example of a display device according to an embodiment.

FIG. 2 is a cross-sectional view illustrating a configuration example of a display portion.

FIG. 3 is a circuit diagram illustrating a configuration of a first pixel circuit.

FIG. 4 is a circuit diagram illustrating a configuration of a second pixel circuit.

FIG. 5 is a circuit diagram illustrating another configuration of the second pixel circuit.

FIG. 6 is a graph illustrating a relationship between an input gray scale to a subpixel and display luminance of the subpixel (with a control example of each light-emitting region appended).

FIG. 7 is a schematic diagram illustrating an example of low gray scale display and high gray scale display.

FIG. 8 is a graph illustrating a relationship between an input gray scale to a subpixel and display luminance of the subpixel (with a control example of each light-emitting region appended).

FIG. 9 is a schematic diagram illustrating an example of low gray scale display and high gray scale display.

FIG. 10 is a graph illustrating a relationship between an input gray scale to a subpixel and display luminance of the subpixel (with a control example of each light-emitting region appended).

FIG. 11 is a graph illustrating a relationship between an input gray scale to a subpixel and display luminance of the subpixel (with a control example of each light-emitting region appended).

FIG. 12 is a graph illustrating a relationship between an input gray scale to a subpixel and display luminance of the subpixel (with a control example of each light-emitting region appended).

FIG. 13 is a plan view illustrating a configuration example of a first light-emitting region and a second light-emitting region in a subpixel.

FIG. 14 is a plan view illustrating a configuration example of the display portion.

FIG. 15 is a plan view illustrating a configuration example of the display portion.

FIG. 16 is a cross-sectional view illustrating a configuration example of the display portion.

FIG. 17 is a plan view illustrating a configuration example of a first light-emitting region and a second light-emitting region in a subpixel.

### DESCRIPTION OF EMBODIMENTS

### First Embodiment

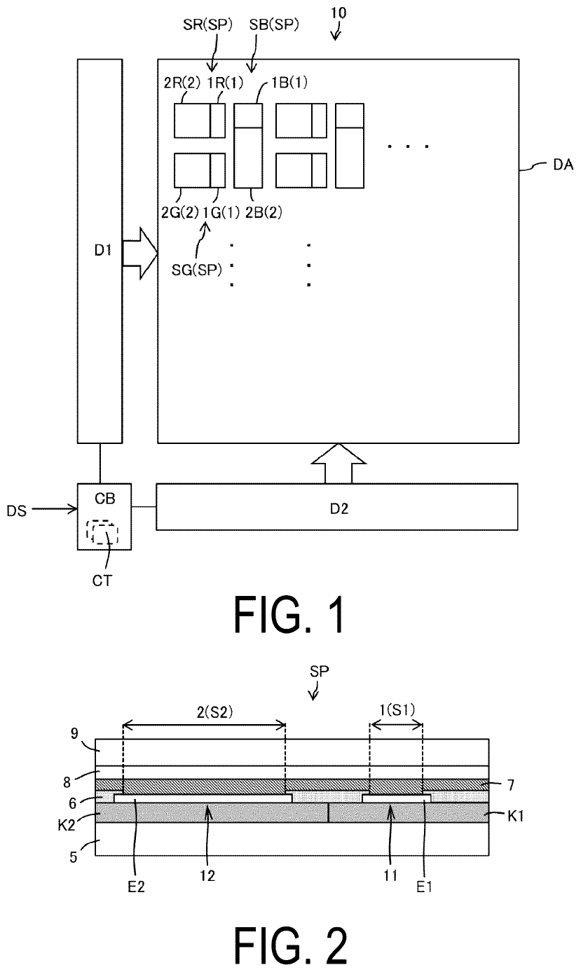

FIG. 1 is a schematic diagram illustrating a configuration example of a display device according to an embodiment. FIG. 2 is a cross-sectional view illustrating a configuration example of a display portion. A display device 10 includes a display portion DA, a first driver D1, a second driver D2, and a control unit CB. The display portion DA includes a plurality of subpixels SP. The plurality of subpixels SP may include a subpixel SR that emits red light, a subpixel SG that emits green light, and a subpixel SB that emits blue light.

The first driver D1 may include a scanning signal line drive circuit. The second driver D2 may include a data signal line drive circuit. The first driver D1 and the second driver D2 are controlled by the control unit CB to drive the plurality of subpixels SP. The control unit CB controls light emission of the plurality of subpixels SP via the first driver D1 and the second driver D2 based on an image signal DS.

Each of the plurality of subpixels SP includes a first light-emitting region 1 including a first area S1 and a second light-emitting region 2 including a second area S2 larger than the first area S1. As illustrated in FIG. 2, the subpixel SP includes a first light-emitting element 11, a first pixel circuit K1 configured to control luminance of the first light-emitting element 11, a second light-emitting element 12, and a second pixel circuit K2 configured to control luminance of the second light-emitting element 12. Accordingly, it is possible to independently control the luminance of the first light-emitting region 1 (the light-emitting region of the first light-emitting element 11) and the luminance of the second light-emitting region 2 (the light-emitting region of the second light-emitting element 12). The first pixel circuit K1 and the second pixel circuit K2 are formed on a substrate 5. A glass substrate, a resin substrate, and the like can be used for the substrate 5. As illustrated in FIG. 1, a shape of a first light-emitting region 1R of the subpixel SR may be different from a shape of a first light-emitting region 1B of the subpixel SB, and a shape of a second light-emitting region 2R of the subpixel SR may be different from a shape of a second light-emitting region 2B of the subpixel SB.

The first light-emitting element 11 includes a lower electrode E1, a light-emitting layer 7, and an upper electrode 8, and the second light-emitting element 12 includes a lower electrode E2, the light-emitting layer 7, and the upper electrode 8. The light-emitting layer 7 and the upper electrode 8 may be shared by the first light-emitting element 11 and the second light-emitting element 12. Edges of the lower electrodes E1 and E2 may be covered with an edge cover film (for example, an organic insulating film) 6, and the upper electrode 8 may be covered with a sealing layer 9. The lower electrodes E1 and E2 may be anodes, and the upper electrode 8 may be a cathode. The lower electrodes E1 and E2 may be light reflective electrodes, and the upper electrode 8 may be a light-transmissive electrode. An area of the lower electrode E2 may be larger than an area of the lower electrode E1. An area of a portion (exposed portion) of the lower electrode E1 not covered with the edge cover film 6 may be equal to the first area S1 of the first light-emitting region 1, and an area of a portion (exposed portion) of the lower electrode E2 not covered with the edge cover film 6 may be equal to the second area S2 of the second light-emitting region 2. The light-emitting layer 7 may be an organic light-emitting layer or a quantum dot light-emitting layer.

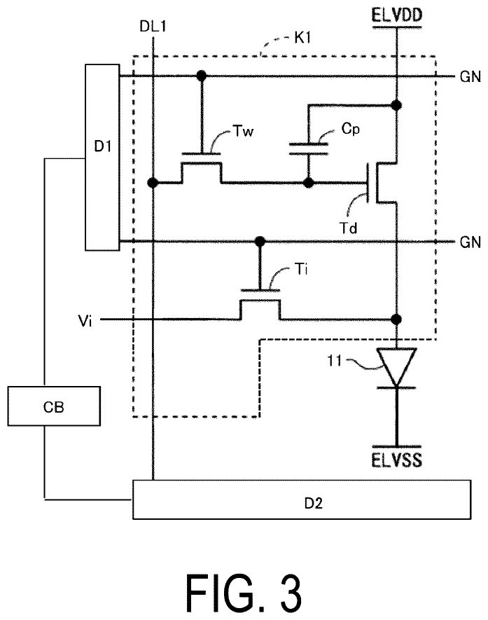

FIG. 3 is a circuit diagram illustrating a configuration of the first pixel circuit. As illustrated in FIG. 3, the first pixel circuit K1 includes a write transistor Tw, a drive transistor Td, and a discharge transistor Ti. Gate terminals of the write transistor Tw and the discharge transistor Ti are connected to scanning signal lines GN, and a gate terminal of the drive transistor Td is connected to a high-potential side power source (ELVDD) via a capacitance element Cp and is also connected to a data signal line DL1 via the write transistor Tw. A source terminal of the drive transistor Td is connected to the high-potential side power source (ELVDD), a drain terminal of the drive transistor Td is connected to an anode of the first light-emitting element 11, and the anode of the first light-emitting element 11 is connected to an initialization power source Vi via the discharge transistor Ti.

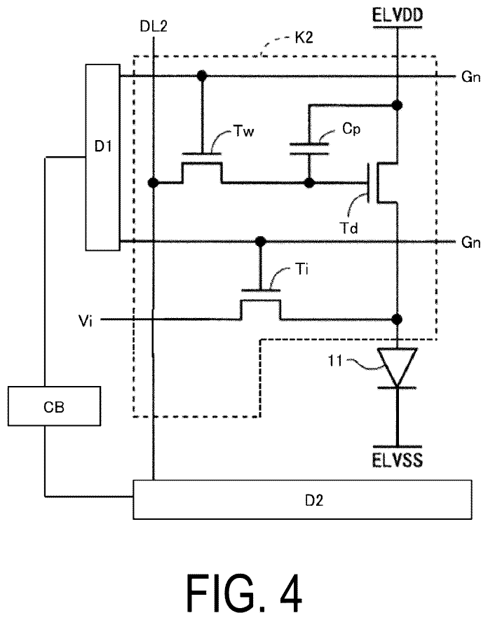

FIG. 4 is a circuit diagram illustrating a configuration of the second pixel circuit. As illustrated in FIG. 4, the second pixel circuit K2 includes a write transistor Tw, a drive transistor Td, and a discharge transistor Ti. Gate terminals of the write transistor Tw and the discharge transistor Ti are connected to scanning signal lines Gn, and a gate terminal of the drive transistor Td is connected to a high-potential side power source (ELVDD) via a capacitance element Cp and is also connected to a data signal line DL2 via the write transistor Tw. A source terminal of the drive transistor Td is connected to the high-potential side power source (ELVDD), a drain terminal of the drive transistor Td is connected to an anode of the second light-emitting element 12, and the anode of the second light-emitting element 12 is connected to an initialization power source Vi via the discharge transistor Ti. A drive current of the second light-emitting element 12 may be monitored, and a process (external compensation) of correcting the drive current of the second light-emitting element 12 in response to the monitoring result may be performed. The external compensation may be performed to the second pixel circuit K2 without performing the external compensation to the first pixel circuit K1, or the external compensation may be performed to the first pixel circuit K1 and the second pixel circuit K2.

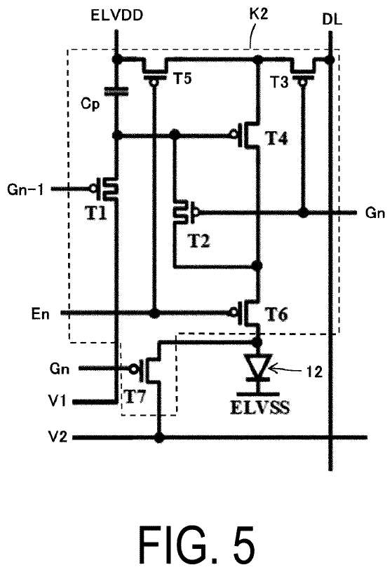

FIG. 5 is a circuit diagram illustrating another configuration of the second pixel circuit. The second pixel circuit K2 includes a pixel capacitance Cp, an initialization transistor T1, a threshold value compensation transistor T2, a write transistor T3, a drive transistor T4, a power source control transistor T5, a light emission control transistor T6, and a discharge transistor T7. The transistors T1 to T7 may be p-type.

A gate terminal of the initialization transistor T1 is connected to a scanning signal line Gn-1 of an (n-1)-th stage, gate terminals of the threshold value compensation transistor T2, the write transistor T3, and the discharge transistor T7 are connected to scanning signal lines Gn of an n-th stage, and a gate terminal of the light emission control transistor T6 is connected to a light emission control line En of the n-th stage. A gate terminal of the drive transistor T4 is connected to a high-potential side power source (ELVDD) via the pixel capacitance Cp and is also connected to an initialization power source V1 via the initialization transistor T1. An anode of the second light-emitting element 12 is connected to an initialization power source V2 via the discharge transistor T7. A drain terminal of the drive transistor T4 is connected to the gate terminal of the drive transistor T4 via the threshold value compensation transistor T2. According to the second pixel circuit K2, the threshold value compensation (internal compensation) of the drive transistor T4 can be performed by the threshold value compensation transistor T2. Not only the second pixel circuit K2 but also the first pixel circuit K1 may be configured to be capable of internal compensation. External compensation may be performed to the second pixel circuit K2 illustrated in FIG. 5.

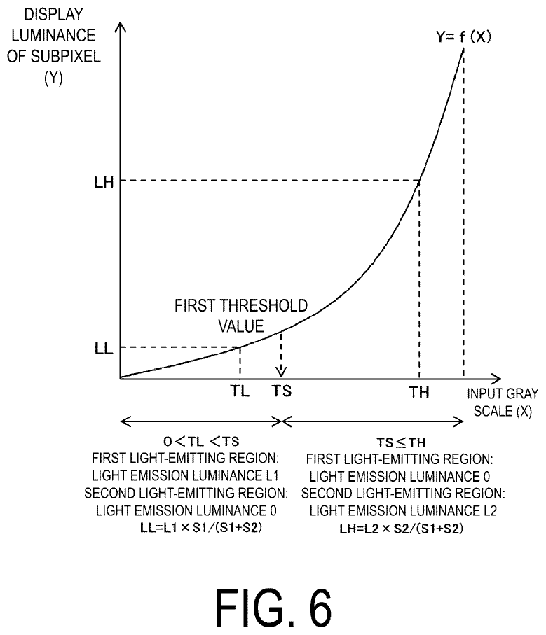

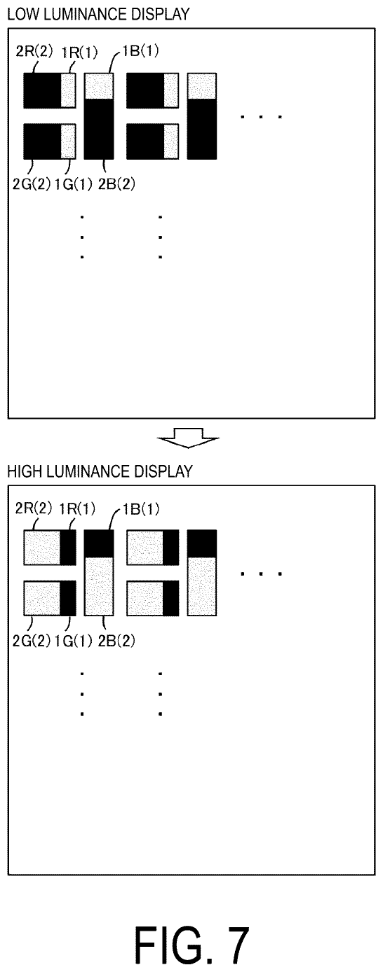

FIG. 6 is a graph illustrating a relationship between an input gray scale to a subpixel and display luminance of the subpixel (with a control example of each light-emitting region appended). An input gray scale X and display luminance Y of the subpixel have a relationship of gamma 2.2, for example, and can be expressed as Y=f(X). FIG. 7 is a schematic diagram illustrating an example of low gray scale display and high gray scale display. As illustrated in FIG. 6 and FIG. 7, the control unit CB causes the first light-emitting region 1 to emit light and causes the second light-emitting region 2 not to emit light in a case in which a gray scale value (input gray scale) represented by the image signal DS is greater than 0 and less than a first threshold value TS, and causes the second light-emitting region 2 to emit light in a case in which the gray scale value (input gray scale) represented by the image signal DS is equal to or greater than the first threshold value TS.

For example, the control unit CB sets light emission luminance of the first light-emitting region 1 to L1 and the light emission luminance of the second light-emitting region 2 to 0 in a case of 0<an input gray scale TL<the first threshold value TS, and sets the light emission luminance of the first light-emitting region 1 to 0 and the light emission luminance of the second light-emitting region 2 to L2 in a case of an input gray scale TH≥the first threshold value TS.

Hereinafter, the display luminance is defined as the light emission luminance multiplied by the contribution to the display corresponding to the area. Assuming that the first area of the first light-emitting region 1 is S1 and the second area of the second light-emitting region 2 is S2, then the display luminance of the first light-emitting region 1=L1×S1/(S1+S2) and the display luminance of the second light-emitting region 2=L2×S2/(S1+S2). The sum of the display luminance of the first light-emitting region 1 and the display luminance of the second light-emitting region 2 is the display luminance (Y) of the subpixel SP.

In FIG. 6, in a case of 0<the input gray scale TL<the first threshold value TS, the light emission luminance of the second light-emitting region 2 is set to 0. Accordingly, when f(TL)=LL, the display luminance of the subpixel LL=L1×S1/(S1+S2) is established, and L1=LL×(S1+S2)/S1 is satisfied. As described above, by providing a plurality of light-emitting regions which are individually controlled in the subpixel SP, L1 (light emission luminance of the first light-emitting region 1)>LL (display luminance of the subpixel SP) is satisfied, and it is possible to increase a current value of the first light-emitting element 11 even in the low gray scale display. That is, display quality is improved by displaying the low gray scale using a stable current region of the first light-emitting element 11. The area ratio S2/S1 may be 2.0 or more, 3.0 or more, or even 5.0 or more.

The light emission of the first light-emitting region 1 may be controlled by using a conversion table CT in which the gray scale value represented by the image signal DS is associated with the gray scale value of the first light-emitting region 1. For example, the control unit CB may convert the input gray scale TH into the converted gray scale T1 (>input gray scale TL) by using the conversion table CT (see FIG. 1) and output the converted gray scale T1 to the second driver D2, and f(T1)=L1 may be satisfied. In other words, in a case in which the gray scale value (input gray scale TL) represented by the image signal DS is less than the first threshold value TS, the gray scale value (converted gray scale T1) of the first light-emitting region 1 may be greater than the gray scale value (input gray scale TL) represented by the image signal DS. The luminance=f(T1)=light emission luminance L1 corresponding to the gray scale value (converted gray scale T1) of the first light-emitting region 1 may be equal to the product of the luminance=f(TL)=LL corresponding to the gray scale value (input gray scale TL) represented by the image signal DS and the value of ratio=(S1+S2)/S1 of the area of the entire light-emitting region of the subpixel to the first area S1.

In FIG. 6 and FIG. 7, in a case of the input gray scale TH≥the first threshold value TS, the light emission luminance of the first light-emitting region 1 is set to 0. Therefore, when f(TH)=LH, the light emission luminance of the second light-emitting region 2 is L2, display luminance of the subpixel LH=L2×S2/(S1+S2) is established. In this case, the light emission of the second light-emitting region 2 may be controlled by using the conversion table CT that associates the gray scale value represented by the image signal DS with the gray scale value T2 of the second light-emitting region 2. For example, the control unit CB may convert the input gray scale TH into the converted gray scale T2 using the conversion table CT (FIG. 1) and output the converted gray scale T2 to the second driver D2, and f(T2)=L2 may be satisfied.

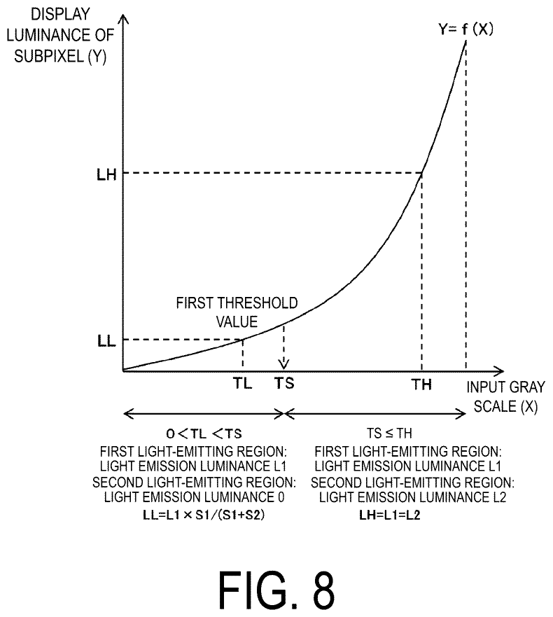

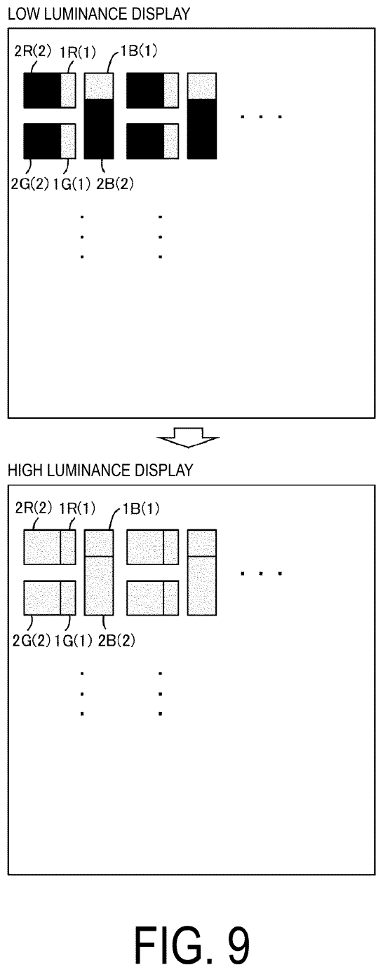

FIG. 8 is a graph illustrating a relationship between an input gray scale to a subpixel and display luminance of the subpixel (with a control example of each light-emitting region appended). FIG. 9 is a schematic diagram illustrating an example of low gray scale display and high gray scale display. In FIG. 8 and FIG. 9, the control unit CB causes the first light-emitting region 1 to emit light and sets the light emission luminance of the second light-emitting region 2 to 0 in a case of 0<the input gray scale TL<the first threshold value TS. Therefore, L1=LL×(S1+S2)/S1 is satisfied, and the display quality of the low gray scale is improved. The control unit CB causes each of the first light-emitting region 1 and the second light-emitting region 2 to emit light in a case of the input gray scale TH≥the first threshold value TS. In a case in which the light emission luminance in the respective light-emitting regions is the same, when f(TH)=LH, the light emission luminance of the first light-emitting region 1 is L1, and the light emission luminance of the second light-emitting region 2 is L2, LH (display luminance of subpixel)=L1=L2 may be satisfied.

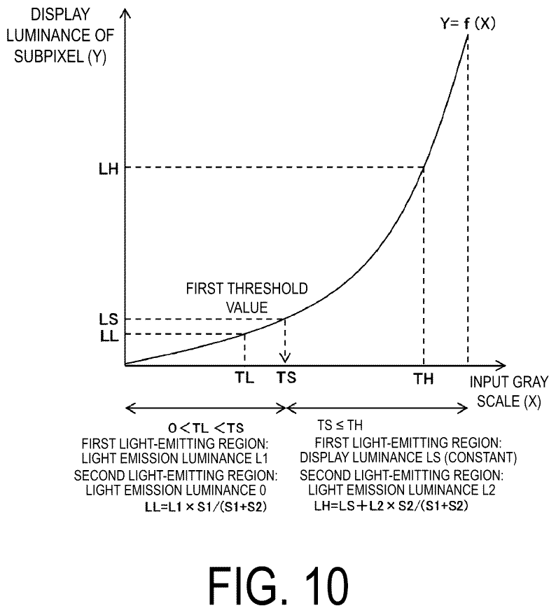

FIG. 10 is a graph illustrating a relationship between an input gray scale to a subpixel and display luminance of the subpixel (with a control example of each light-emitting region appended). In FIG. 10, the control unit CB causes the first light-emitting region 1 to emit light and sets the light emission luminance of the second light-emitting region 2 to 0 in a case of 0<the input gray scale TL<the first threshold value TS. Therefore, L1=LL×(S1+S2)/S1 is satisfied, and the display quality of the low gray scale is improved. In a case of the input gray scale TH>the first threshold value TS, the control unit CB causes each of the first light-emitting region 1 and the second light-emitting region 2 to emit light, and maintains the light emission luminance of the first light-emitting region 1 to be constant. In this case, when f(TS)=LS, the light emission luminance of the second light-emitting region 2 is L2, the display luminance of the first light-emitting region 1=LS (constant), the display luminance of the subpixel LH=LS+L2×S2/(S1+S2) may be satisfied. L2×S2/(S1+S2) is the display luminance of the second light-emitting region 2.

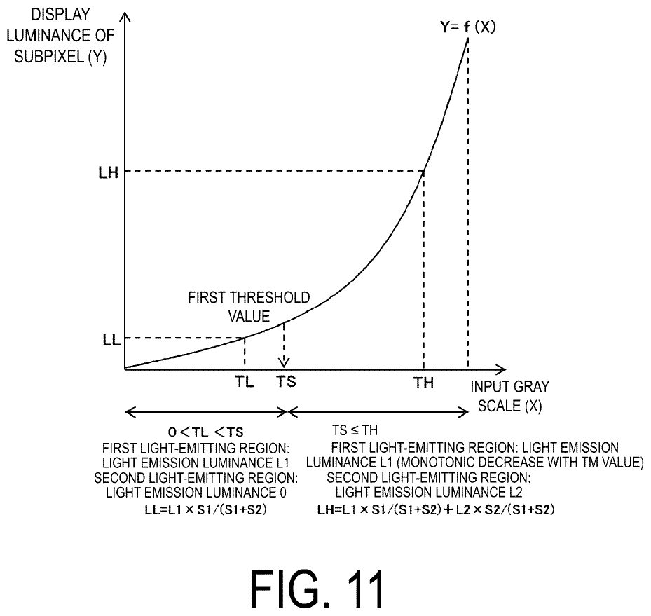

FIG. 11 is a graph illustrating a relationship between an input gray scale to a subpixel and display luminance of the subpixel (with a control example of each light-emitting region appended). In FIG. 11, the control unit CB causes the first light-emitting region 1 to emit light and sets the light emission luminance of the second light-emitting region 2 to 0 in a case of 0<the input gray scale TL<the first threshold value TS. Therefore, L1=LL×(S1+S2)/S1 is satisfied, and the display quality of the low gray scale is improved. In a case of the input gray scale TH>the first threshold value TS, the control unit CB causes each of the first light-emitting region 1 and the second light-emitting region 2 to emit light and decreases the luminance (light emission luminance) of the first light-emitting region 1 as the input gray scale TH increases (monotonic decrease). In this case, when f(TS)=LS, the light emission luminance of the first light-emitting region 1 is L1, and the light emission luminance of the second light-emitting region 2 is L2, the display luminance of the subpixel LH=L1×S1/(S1+S2)+L2×S2/(S1+S2) may be satisfied.

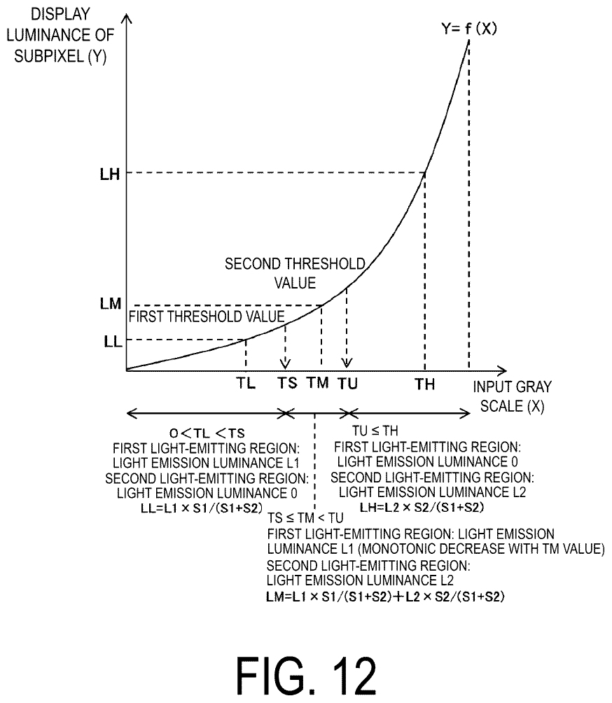

FIG. 12 is a graph illustrating a relationship between an input gray scale to a subpixel and display luminance of the subpixel (with a control example of each light-emitting region appended). In FIG. 12, the control unit CB causes the first light-emitting region 1 to emit light and sets the light emission luminance of the second light-emitting region 2 to 0 in a case of 0<the input gray scale TL<the first threshold value TS. Therefore, L1=LL×(S1+S2)/S1 is satisfied, and the display quality of the low gray scale is improved. In a case of the first threshold TS≤an input gray scale TM<a second threshold value TU, the control unit CB causes each of the first light-emitting region 1 and the second light-emitting region 2 to emit light and decreases the luminance (light emission luminance) of the first light-emitting region 1 as the input gray scale increases (monotonic decrease). In this case, when f(TS)=LS, the light emission luminance of the first light-emitting region 1 is L1, and the light emission luminance of the second light-emitting region 2 is L2, the display luminance of the subpixel LH=L1×S1/(S1+S2)+L2×S2/(S1+S2) may be satisfied. The control unit CB sets the light emission luminance of the first light-emitting region 1 to 0 in a case of the second threshold value TU≤the input gray scale TH. Therefore, when f(TH)=LH, the light emission luminance of the second light-emitting region 2 is L2, the display luminance of the subpixel LH=L2×S2/(S1+S2) may be satisfied.

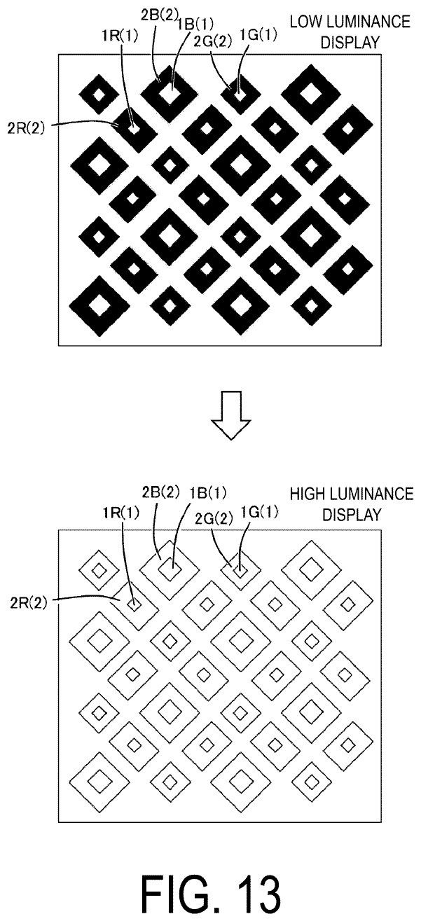

FIG. 13 is a plan view illustrating a configuration example of a first light-emitting region and a second light-emitting region in a subpixel. As illustrated in FIG. 13, the first light-emitting region 1 may be surrounded by the second light-emitting region 2. In this case, the first light-emitting region 1 may be provided at a position overlapping the center of the second light-emitting region 2 (for example, luminance centroid). The second light-emitting region 2 has a shape including a hollowed-out portion, and it can be said that the first light-emitting region 1 is disposed within the hollowed-out portion. In the PenTile arrangement in which the number of subpixels SG is greater than the number of subpixels SR and the number of subpixels SB, an area of a first light-emitting region 1G of the subpixel SG<an area of the first light-emitting region 1R of the subpixel SR<an area of the first light-emitting region 1B of the subpixel SB may be satisfied.

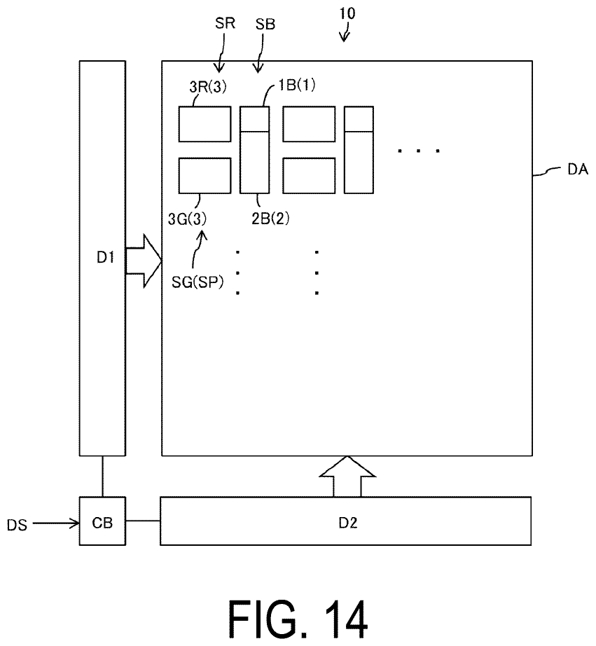

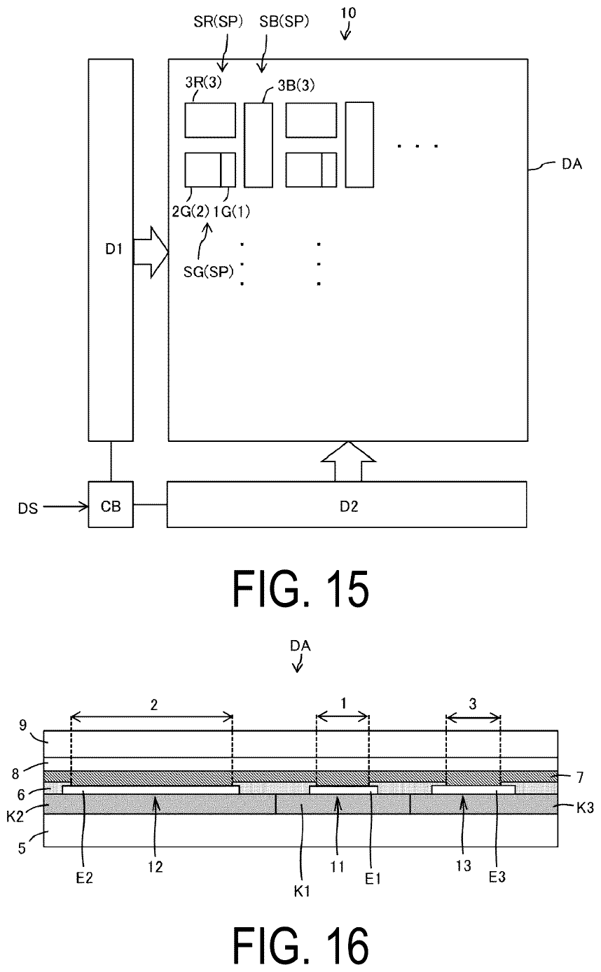

FIG. 14 and FIG. 15 are plan views illustrating configuration examples of the display portion. As illustrated in FIG. 14, the display portion DA may include the subpixel SR (red light emission) formed of a single light-emitting region 3R(3), the subpixel SG (green light emission) formed of a single light-emitting region 3G(3), and the subpixel SB (blue light emission) including the first light-emitting region 1 and the second light-emitting region 2. That is, the light-emitting regions are not divided in the subpixel SR and the subpixel SG. As illustrated in FIG. 15, the display portion DA may include the subpixel SR (red light emission) formed of the single light-emitting region 3R(3), the subpixel SG (green light emission) including the first light-emitting region 1 and the second light-emitting region 2, and the subpixel SB (blue light emission) formed of a single light-emitting region 3B(3).

FIG. 16 is a cross-sectional view illustrating a configuration example of the display portion. In FIG. 16, the subpixel SG may include the first pixel circuit K1 corresponding to the first light-emitting region 1 and the second pixel circuit K2 corresponding to the second light-emitting region 2, and the subpixel SB may include a third pixel circuit K3 corresponding to the single light-emitting region 3B(3). The single light-emitting region 3B is a light-emitting region of a third light-emitting element 13 connected to the third pixel circuit K3. The third light-emitting element 13 includes a lower electrode E3, the light-emitting layer 7, and the upper electrode 8. The light-emitting layer 7 and the upper electrode 8 may be shared by from the first light-emitting element 11 to the third light-emitting element 13.

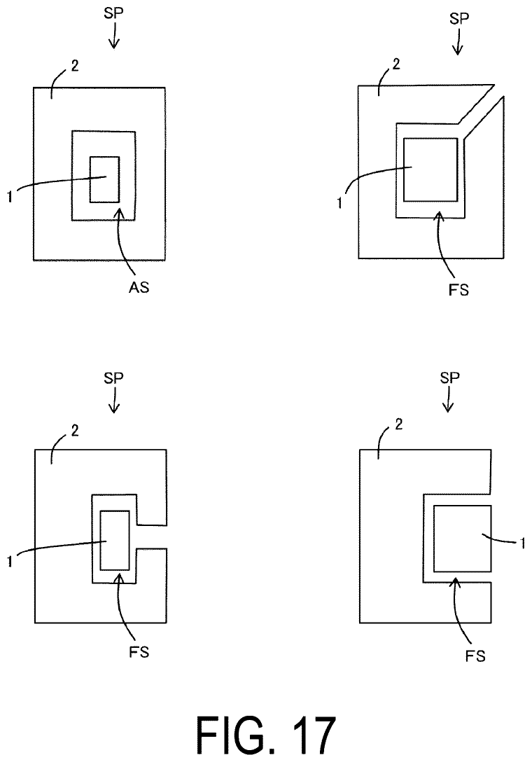

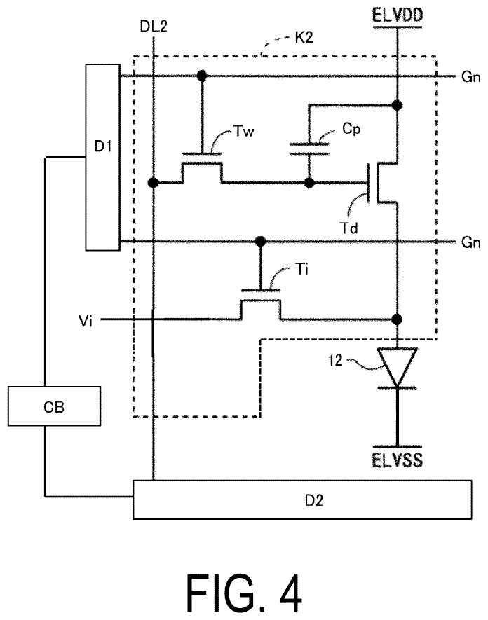

FIG. 17 is a plan view illustrating a configuration example of a first light-emitting region and a second light-emitting region in a subpixel. As illustrated in FIG. 17, the first light-emitting region 1 may be completely or incompletely surrounded by the second light-emitting region 2. For example, the second light-emitting region 2 may have a shape including a hollowed-out portion AS, and the first light-emitting region 1 may be disposed in the hollowed-out portion AS of the second light-emitting region 2. The second light-emitting region 2 may have a shape including a notch portion FS, and the first light-emitting region 1 may be disposed in the notch portion FS of the second light-emitting region 2. The first light-emitting region 1 may be disposed inside the second light-emitting region 2 having a C-shape.

The embodiments described above are for the purpose of illustration and description and are not intended to be limiting. It will be apparent to those skilled in the art that many variations will be possible in accordance with these examples and descriptions.

1. A display device, comprising:
a display portion including a plurality of subpixels; and
a control unit configured to control light emission of the plurality of subpixels based on an image signal,
wherein each of the plurality of subpixels includes a first light-emitting region including a first area and a second light-emitting region including a second area larger than the first area,
the control unit causes the first light-emitting region to emit light and the second light-emitting region not to emit light in a case in which a gray scale value represented by the image signal is greater than 0 and less than a first threshold value, and causes the second light-emitting region to emit light in a case in which the gray scale value represented by the image signal is equal to or greater than the first threshold value.

2. The display device according to claim 1,
wherein the control unit causes the first light-emitting region not to emit light in a case in which the gray scale value represented by the image signal is equal to or greater than the first threshold value.

3. The display device according to claim 1,
wherein the control unit causes the first light-emitting region and the second light-emitting region to emit light in a case in which the gray scale value represented by the image signal is equal to or greater than the first threshold value.

4. The display device according to claim 3,
wherein the control unit maintains luminance of the first light-emitting region to be constant in a case in which the gray scale value represented by the image signal is equal to or greater than the first threshold value.

5. The display device according to claim 3,
wherein the control unit decreases luminance of the first light-emitting region as the gray scale value represented by the image signal increases in a case in which the gray scale value represented by the image signal is equal to or greater than the first threshold value.

6. The display device according to claim 5,
wherein the control unit causes the first light-emitting region not to emit light in a case in which the gray scale value represented by the image signal is equal to or greater than a second threshold value that is greater than the first threshold value.

7. The display device according to claim 1,
wherein the control unit controls light emission of the first light-emitting region and the second light-emitting region by using a conversion table associating the gray scale value represented by the image signal, a gray scale value of the first light-emitting region, and a gray scale value of the second light-emitting region.

8. The display device according to claim 7,
wherein the gray scale value of the first light-emitting region is greater than the gray scale value represented by the image signal in a case in which the gray scale value represented by the image signal is less than the first threshold value.

9. The display device according to claim 8,
wherein in a case in which the gray scale value represented by the image signal is less than the first threshold value, the luminance corresponding to the gray scale value of the first light-emitting region is equal to a product of the luminance corresponding to the gray scale value represented by the image signal and a value of ratio of an area of an entire light-emitting region of the subpixel to the first area.

10. The display device according to claim 1,
wherein the subpixel includes a first light-emitting element corresponding to the first light-emitting region, a second light-emitting element corresponding to the second light-emitting region, a first pixel circuit connected to the first light-emitting element, and a second pixel circuit connected to the second light-emitting element.

11. The display device according to claim 10,
wherein the first light-emitting region and the second light-emitting region include a light-emitting layer common to the first light-emitting element and the second light-emitting element.

12. The display device according to claim 10,
wherein the control unit performs correction of a drive current of the second light-emitting element, but does not perform correction of a drive current of the first light-emitting element.

13. The display device according to claim 1,
wherein the second light-emitting region has a shape including a notch portion or a hollowed-out portion and the first light-emitting region is disposed in the notch portion or the hollowed-out portion.

14. The display device according to claim 1,
wherein the first light-emitting region is surrounded by the second light-emitting region.

15. The display device according to claim 14,
wherein the first light-emitting region overlaps a luminance centroid of the second light-emitting region in a plan view.

16. The display device according to claim 1,
wherein the display portion includes another subpixel formed of a single light-emitting region.

17. The display device according to claim 16,
wherein each of the plurality of subpixels includes a first pixel circuit corresponding to the first light-emitting region and a second pixel circuit corresponding to the second light-emitting region, and the other subpixel includes a third pixel circuit corresponding to the single light-emitting region.
